(19) United States
(12) Patent Application Publication
(10) Pub. No.: US 2021/0109738 A1
(43) Pub. Date: Apr. 15, 2021

(54) OTA UPDATE CONTROL METHOD AND SYSTEM

(71) Applicants: HYUNDAI MOTOR COMPANY, Seoul (KR); KIA MOTORS CORPORATION, Seoul (KR)

(72) Inventor: Jae Won JUNG, Hwaseong-si (KR)

(73) Assignees: HYUNDAI MOTOR COMPANY, Seoul (KR); KIA MOTORS CORPORATION, Seoul (KR)

(21) Appl. No.: 16/848,316

(22) Filed: Apr. 14, 2020

(30) Foreign Application Priority Data
Oct. 11, 2019 (KR) 10-2019-0125964

(51) Int. Cl. G06F 8/65; B60W 50/00

(52) U.S. Cl. CPC G06F 8/65; B60W 2050/0067; B60W 2556/45; B60W 50/0098

(57) ABSTRACT

An over-the-air (OTA) update control method includes: receiving, by a management controller, update data from an OTA server; transmitting, by the management controller, OTA update information to an communication controller; transmitting, by the communication controller, the OTA update information to a user terminal; outputting, by the user terminal, an update list and update details based on the OTA update information; receiving either an approval or a denial of OTA update from the user terminal; and executing, by the management controller, the OTA update based on the approval of the OTA update.

### CROSS-REFERENCE TO RELATED APPLICATION

This application claims priority to and the benefit of Korean Patent Application No. 10-2019-0125964, filed on Oct. 11, 2019, the entire contents of which are incorporated herein by reference.

### FIELD

The present disclosure relates to an over-the-air (OTA) update control method and system.

### BACKGROUND

The statements in this section merely provide background information related to the present disclosure and may not constitute prior art.

In general, software installed in a vehicle may be wirelessly updated using wireless air data over the air (OTA). In such vehicle OTA update, wireless transmission and update to a customer's vehicle may be performed through a server to update software desired for management of the vehicle, so as to additionally enhance merchantability of the vehicle and efficiently cope with a problem with quality of the vehicle.

FIG. 1 is a block diagram showing the configuration of a conventional OTA update system.

Referring to FIG. 1, the conventional OTA update system may include an OTA server 100 for storing update data which is controller update information, an OTA management controller 200 for wirelessly receiving and managing the update data, and an OTA execution controller 300 to be updated as needed.

In this conventional OTA update system, for controller wireless update, the management controller 200 may receive the update data from the OTA server 100 through a communication module 210 and transmit the update data to the execution controller 300 according to OTA management logic based on vehicle status information. The execution controller 300 may execute update based on the received update data. Here, the vehicle status information may include battery state information, travel state information, execution controller operation state information, and power state information.

In addition, in the conventional OTA update system, when an ignition (IG) OFF & safe status is satisfied after the vehicle is parked, an OTA update approval screen is displayed. Then, when a driver exits the vehicle after approval, update may be executed based on the update data wirelessly downloaded from the management controller 200 to the execution controller 300.

However, we have discovered that in this conventional OTA update system, as update data increases in size, an OTA controller update time, during which use of the vehicle is impossible, increases.

### SUMMARY

The present disclosure is directed to an over-the-air (OTA) update control method and system that substantially obviates one or more problems due to limitations and disadvantages of the related art.

The present disclosure provides an OTA update control method and system in which a user can perform OTA update even externally of a vehicle through a user terminal connected to the vehicle.

Objects of the present disclosure devised to solve the problems are not limited to the aforementioned object, and other unmentioned objects will be clearly understood by those skilled in the art based on the following detailed description of the present disclosure.

In one form of the present disclosure, as embodied and broadly described herein, an over-the-air (OTA) update control method: includes: receiving, by a management controller, update data from an OTA server; transmitting, by the management controller, OTA update information to an communication controller; transmitting, by the communication controller, the OTA update information to a user terminal; outputting, by the user terminal, an update list and update details based on the OTA update information; receiving either an approval or a denial of OTA update from the user terminal; and executing, by the management controller, the OTA update based on the approval of the OTA update.

The OTA update information may include: at least one of vehicle status information, information about execution controllers to be updated, or contents to be updated.

The outputting the update list and update details may include: determining, by the management controller, execution controllers to be updated based on predetermined priorities; transmitting, by the management controller, an update list of the execution controllers determined according to the predetermined priorities to the user terminal; and performing, by the management controller, a control operation such that the user terminal outputs the update list of the execution controllers and update details.

In one form, receiving either the approval or denial may include receiving or not receiving an OTA update immediate approval from the user terminal.

The OTA update control method may further include: when the OTA update immediate approval is received, determining whether to receive the OTA update based on a state of charge (SOC) of a battery of a vehicle among vehicle status information from the user terminal.

The determining whether to receive the OTA update based on the SOC of the battery may include: calculating power to be consumed during the OTA update based on a driving current by execution controllers to be updated and an OTA update time based on update data capacity by the execution controllers; calculating the SOC after completion of the OTA update based on the calculated power; and determining a vehicle updatable status after the OTA update based on the calculated SOC.

The OTA update control method may further include: when the OTA update immediate approval is not received, receiving either the approval or denial of the OTA update based on a predetermined update schedule.

The receiving either the approval or denial of the OTA update based on the predetermined update schedule may include: receiving the approval when a current time is within a range of an OTA update reservation setting time based on the predetermined update schedule.

In one form, executing the OTA update may include updating the execution controllers to the update data upon receiving the approval of the OTA update from the user terminal.

In another aspect of the present disclosure, an OTA update control system includes: an OTA server; a management controller connected to the OTA server through wireless communication to receive update data from the OTA server, a plurality of execution controllers for executing OTA update based on the update data received from the management controller, an communication controller connected to the management controller through intra-vehicle communication; and a user terminal connected to the communication controller through wireless communication. In particular, the management controller transmits OTA update information to the user terminal through the communication controller, and receives either an OTA update approval or a denial of the OTA update based on the OTA update information from the user terminal through the communication controller, and the execution controllers execute the OTA update based on the OTA update approval.

It is to be understood that both the foregoing general description and the following detailed description of the present disclosure are exemplary and explanatory and are intended to provide further explanation of the present disclosure.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a block diagram showing the configuration of a conventional over-the-air (OTA) update system;

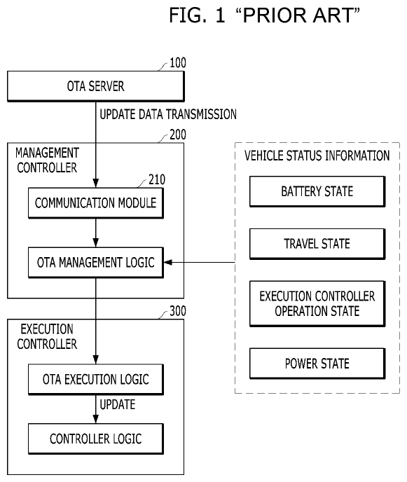

FIG. 2 is a block diagram showing the configuration of an OTA update control system; and

FIG. 3 is a flowchart illustrating an OTA update control method.

The drawings described herein are for illustration purposes only and are not intended to limit the scope of the present disclosure in any way.

### DETAILED DESCRIPTION DISCLOSURE

The following description is merely exemplary in nature and is not intended to limit the present disclosure, application, or uses. It should be understood that throughout the drawings, corresponding reference numerals indicate like or corresponding parts and features.

Reference will now be made in detail to apparatuses and various methods according to the exemplary forms of the present disclosure, examples of which are illustrated in the accompanying drawings. The suffixes “module” and “unit” of elements herein are used for convenience of description and thus can be used interchangeably, and do not have any distinguishable meanings or functions.

In the description of exemplary forms, it will be understood that, when an element is referred to as being “on” or “under” or “before” or “after” another element, the element can be directly adjacent to the other element, or one or more intervening elements may also be present.

It will be understood that, although the terms “first”, “second”, “A”, “B”, “(a)”, “(b)”, etc. may be used herein to describe various elements of the present disclosure, these terms are only used to distinguish one element from another element, and the essential order or sequence of the corresponding elements is not limited by these terms. It will be understood that, when one element is referred to as being “connected to”, “coupled to”, or “accessing” another element, the one element may be “connected to”, “coupled to”, or “access” another element via a further element, or the one element may be directly connected to or directly access the other element.

The terms “comprises”, “includes”, and “has” when used herein should be interpreted not to exclude other elements but to further include such other elements since the corresponding elements may be included unless mentioned otherwise. All terms including technical or scientific terms have the same meanings as generally understood by a person having ordinary skill in the art to which the present disclosure pertains unless mentioned otherwise. Generally used terms, such as terms defined in a dictionary, should be interpreted to coincide with meanings in the related art from the context. Unless differently defined in the present disclosure, such terms should not be interpreted in an ideal or excessively formal manner.

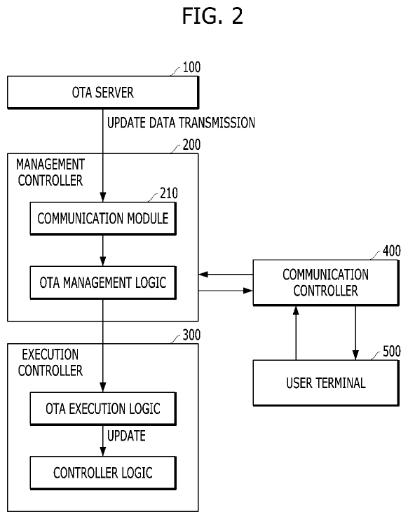

FIG. 2 is a block diagram showing the configuration of an over-the-air (OTA) update control system according to one form of the present disclosure.

Referring to FIG. 2, the OTA update control system may include an OTA server 100, a management controller 200, a plurality of execution controllers 300, a communication controller 400, and a user terminal 500. And the communication controller 400 may include an AVN and a head unit. Here, each of the management controller 200, the plurality of execution controllers 300, the communication controller 400 includes a processor and a non-transitory medium containing program instructions executed by the processor.

The OTA server 100 may mean a server supporting OTA which is a standard for transmission/reception of information about system registration in a wireless communication system.

The OTA server 100 may be connected to the management controller 200 through wireless communication. The OTA server 100 may transmit update data to the management controller 200 through wireless communication. The update data may include firmware or software. Here, update data may include a firmware or a software.

The management controller 200 is a controller which manages OTA update, and may include a communication module 210 which is wirelessly connected to the OTA server 100 to transmit/receive data to/from the OTA server 100.

Accordingly, the management controller 200 may receive (or download) the update data from the OTA server 100 through wireless communication. In addition, the management controller 200 may transmit the downloaded update data to the execution controllers 300. In some forms, controller area network (CAN) or Ethernet communication may be employed for intra-vehicle communication.

On the other hand, the management controller 200 may transmit OTA update information to the communication controller 400 using intra-vehicle communication. That is, the management controller 200 may transmit the OTA update information to the user terminal 500 through the communication controller 400.

Here, the OTA update information may include vehicle status information, information about the execution controllers 300 to be updated, and an update list.

In some forms, the vehicle status information may include battery state information, travel state information, execution controller operation state information, and power state information.

In some forms, the update list may be information about update priorities of the execution controllers 300 to be updated. Here, among the execution controllers 300 to be updated, execution controllers directly connected with safety may have higher priorities.

Therefore, the management controller 200 may transmit an OTA update list based on OTA update priorities to the user terminal 500 through the communication controller 400, and perform a control operation such that the user terminal 500 outputs the update list and update details. Here, the update list may be information about a list of the execution controllers 300 to be updated. The update details may be contents to be updated in the execution controllers 300. On the other hand, the management controller 200 may calculate vehicle OTA updatable status information based on the vehicle status information and transmit the calculated information to the user terminal 500 through the communication controller 400. Here, updatable status information is information indicating whether an update is available or not.

In some forms, in the case where the vehicle status information is battery state information, the management controller 200 may determine whether OTA update of the execution controllers 300 can be executed, based on a current state of charge (SOC) of a battery of a vehicle. That is, the management controller 200 may calculate the SOC of the battery of the vehicle posterior to OTA update completion.

To this end, the management controller 200 may calculate power to be consumed during OTA update based on power by the execution controllers 300 to be updated and an OTA update time, as in the following equation 1.

Power to be consumed during update=controller power*update time

Update time=(update data capacity)/(intra-vehicle update communication speed) [Equation 1]:

where, the controller power is power based on driving current by the execution controllers 300, and the update time is an OTA update time based on update data capacity by the execution controllers 300.

Thereafter, the management controller 200 may determine a vehicle updatable status after OTA update based on the vehicle battery SOC calculated as in the above equation 1. That is, the management controller 200 may calculate the vehicle battery SOC posterior to OTA update completion.

Then, the management controller 200 may transmit information about the vehicle updatable status to the user terminal 500 through the communication controller 400.

In some forms, in the case where the vehicle battery SOC after OTA update is lower than or equal to a predetermined level, the management controller 200 may perform a control operation to output a warning that the vehicle needs to travel for a predetermined time or more to charge the battery, to a user through the communication controller 400 and the user terminal 500.

In some forms, upon determining that the vehicle battery SOC after OTA update is lower than or equal to the predetermined level and is so low that the vehicle cannot be restarted, the management controller 200 may output a warning that the vehicle cannot be restarted, to the user through the communication controller 400 and the user terminal 500, and perform a control operation such that OTA update is not started. On the other hand, the management controller 200 may receive either OTA update approval or non OTA update approval based on the vehicle OTA updatable status information from the user terminal 500.

In some forms, the management controller 200 may receive or not receive OTA update immediate approval from the user terminal 500. Upon receiving the OTA update immediate approval, the management controller 200 may receive either OTA update approval or non OTA update approval corresponding to the vehicle updatable status information from the user terminal 500.

Upon receiving no OTA update immediate approval, the management controller 200 may receive an OTA update schedule from the user terminal 500 through the communication controller 400. Here, the OTA update schedule may include an OTA update reservation setting time input by the user. As a result, the management controller 200 may determine whether the current time is within the range of the OTA update reservation setting time.

When the current time is within the range of the OTA update reservation setting time, the management controller 200 may receive or not receive the OTA update approval corresponding to the vehicle updatable status information from the user terminal 500.

On the other hand, the management controller 200 may approve OTA update based on a travel state of the vehicle.

In some forms, when the vehicle is in a stop state (IG OFF state), the management controller 200 may receive OTA update approval through the communication controller 400. Then, the management controller 200 may transmit update data to the execution controllers 300 such that the execution controllers 300 execute OTA update based on the update data.

On the other hand, the management controller 200 may receive a user input from the user terminal 500 through the communication controller 400. That is, the management controller 200 may receive either OTA update approval or non OTA update approval corresponding to the OTA update information from the user terminal 500 through the communication controller 400. Then, the management controller 200 may transmit update data to the execution controllers 300 such that the execution controllers 300 execute OTA update based on the update data.

Meanwhile, in the case where there is a controller to be updated irrespective of the transmission of the OTA update information to the communication controller 400, the management controller 200 may determine whether OTA update is approved through the communication controller 400 under the condition that the vehicle is in the IG OFF state. When the user approves OTA update, the management controller 200 may immediately perform the OTA update.

The execution controllers 300 may execute OTA update based on update data received from the management controller 200 and OTA execution logic. That is, in response to OTA update approval received from the user terminal 500, the execution controllers 300 may execute the OTA update with the received update data and update logic thereof.

In some forms, in the case where the management controller 200 receives OTA update approval information of the user input through the communication controller 400 under the condition that the vehicle is in the IG OFF state, the execution controllers 300 may execute OTA update thereof based on update data received from the management controller 200.

In some forms, in the case where the management controller 200 receives OTA update approval information of the user from the user terminal 500, the execution controllers 300 may execute OTA update thereof based on update data received from the management controller 200.

In some forms, in the case where the management controller 200 receives an OTA update reservation setting time from the user terminal 500 and the current time is within the range of the reservation setting time, the execution controllers 300 may execute OTA update thereof based on update data received from the management controller 200.

The communication controller 400 may mean a multimedia terminal for a vehicle in which an audio system, a video system and a navigation system are integrated in the form of one unit.

The communication controller 400 may be connected to the management controller 200 through intra-vehicle communication and to the user terminal 500 through wireless communication. In some forms, the communication controller 400 may be connected to the user terminal 500 through a connected service.

The communication controller 400 may provide the connected service to the user terminal 500, and provide information about the execution controllers 300 to be updated and the OTA update information to the user terminal 500 through the connected service.

The user terminal 500 may be an electronic device capable of transmitting/receiving data to/from other devices through wired/wireless communication. For example, the user terminal 500 may include a smartphone, a tablet, a personal computer (PC), a personal digital assistant (PDA), and a smart television (TV). These are merely illustrative, and the user terminal 500 is not limited thereto.

The user terminal 500 may be connected to the communication controller 400 through an application, and transmit/receive data to/from the communication controller 400 through wireless communication.

Accordingly, the user terminal 500 may receive the vehicle status information, the information about the execution controllers 300 to be updated, and the OTA update information from the management controller 200.

In addition, the user terminal 500 may transmit an update execution command for the execution controllers 300 to the management controller 200 through the communication controller 400 based on a user input.

In some forms, the user terminal 500 may input an OTA update immediate execution command for the execution controllers 300 based on a user input.

In some forms, the user terminal 500 may set an OTA update schedule for the execution controllers 300, and input an OTA update reservation setting time such that OTA update is automatically executed according to the schedule.

In some forms, the user terminal 500 may input an OTA update execution command at a time desired by the user by virtue of user access through an application. On the other hand, the user terminal 500 may output OTA update information of the execution controllers 300 to be updated. As a result, the user terminal 500 may output an update list corresponding to the execution controllers 300 to be updated and update details corresponding to contents to be updated.

In some forms, the user terminal 500 may output a list of the execution controllers 300 in the order of descending priorities based on update priorities of a received OTA update list.

In some forms, the user terminal 500 may output the vehicle battery SOC based on the vehicle status information received from the management controller 200. Then, the user terminal 500 may input OTA update approval of the user corresponding to the vehicle battery SOC.

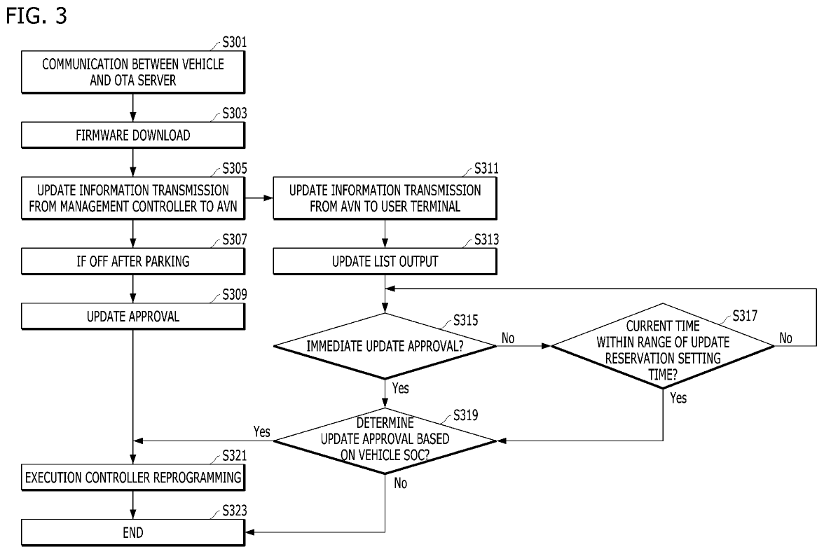

FIG. 3 is a flowchart illustrating an OTA update control method according to one form of the present disclosure.

Referring to FIG. 3, the OTA server 100 and the management controller 200 in the vehicle may perform wireless communication therebetween (S301).

After step S301, the management controller 200 may receive update data desired for OTA update from the OTA server 100 (S303). At this time, the management controller 200 may download the update data when the vehicle is traveling.

After step S303, the management controller 200 may transmit OTA update information to the communication controller 400 (S305). The OTA update information may include vehicle status information, information about the execution controllers 300 to be updated, and an update list.

After step S305, when the vehicle is in the stop state (IG OFF state) (S307), the management controller 200 may receive OTA update approval from the user terminal 500 through the communication controller 400 (S309).

After step S309, the management controller 200 may transmit the update data received from the OTA server 100 to the execution controllers 300 such that the execution controllers 300 execute OTA update based on the update data (S321).

On the other hand, after step S305, the communication controller 400 may transmit the OTA update information received from the management controller 200 to the user terminal 500 (S311).

After step S311, the user terminal 500 may output an update list and update details based on the OTA update information (S313). At this time, the update list may be output in order determined by predetermined priorities.

After step S313, the user terminal 500 may receive or not receive update immediate approval from the user (S315).

In the case where the update immediate approval from the user is input (YES of S315), the user terminal 500 may output vehicle battery SOC information, and then may receive OTA update approval or may not receive the OTA update approval from the user (S319). The receiving step (S319) may also mean that the user terminal 500 may receive either approving or not approving OTA update from the user.

On the other hand, in the case where the update immediate approval from the user is not input (NO of S315), the management controller 200 may determine whether the current time is within the range of a predetermined update reservation setting time (S317).

In the case where the current time is not within the range of the predetermined update reservation setting time (NO of S317), the method may return to the above step S315.

In the case where the current time is within the range of the predetermined update reservation setting time (YES of S317), the user terminal 500 may output vehicle battery SOC information, and then receive either OTA update approval or not receive the OTA update approval from the user (S319).

In the case where the OTA update approval from the user is input (YES of S319), the management controller 200 may transmit the update data received from the OTA server 100 to the execution controllers 300 such that the execution controllers 300 execute OTA update based on the update data (S321).

In the case where the OTA update approval from the user is not input (NO of S319), the OTA update control may be ended.

The above-described method according to one form may be implemented as a computer-executable program and stored on a computer-readable recording medium. Examples of the computer-readable recording medium may include a read-only memory (ROM), a random access memory (RAM), a compact disc read-only memory (CD-ROM), a magnetic tape, a floppy disk, and an optical data storage device. The computer-readable recording medium may be distributed over networked computer systems so that a computer-readable code is stored and executed in a distributed fashion. Also, functional programs, code, and code segments for accomplishing the above-stated method may be easily constructed by programmers skilled in the art to which the form pertains.

As is apparent from the above description, in an OTA update control method and system according to the present disclosure, a driver can perform OTA update even externally of a vehicle through a user terminal. Therefore, the driver can efficiently control an OTA update execution time, thereby preventing the inconvenience that use of the vehicle is impossible for an IG OFF time.

In addition, information about execution controllers to be updated and contents to be updated can be provided to the driver and recognized thereby.

It will be appreciated by those skilled in the art that the effects achievable through the present disclosure are not limited to those that have been particularly described hereinabove and that other unmentioned effects of the present disclosure will be more clearly understood from the above detailed description.

The above detailed description is not to be construed as limiting the present disclosure in any aspect, but is to be considered by way of example. The scope of the present disclosure should be determined by reasonable interpretation of the accompanying claims, and all equivalent modifications made without departing from the scope of the present disclosure.

What is claimed is:

1. An over-the-air (OTA) update control method comprising:
receiving, by a management controller, update data from an OTA server;
transmitting, by the management controller, OTA update information to an communication controller;
transmitting, by the communication controller, the OTA update information to a user terminal;
outputting, by the user terminal, an update list and update details based on the OTA update information;
receiving either an approval or a denial of OTA update from the user terminal; and
executing, by the management controller, the OTA update based on the approval of the OTA update.

2. The OTA update control method according to claim 1, wherein the OTA update information comprises at least one of vehicle status information, information about execution controllers to be updated, or contents to be updated.

3. The OTA update control method according to claim 2, wherein executing the OTA update comprises updating the execution controllers upon receiving the approval of the OTA update from the user terminal.

4. The OTA update control method according to claim 1, wherein outputting the update list and update details comprises:
determining, by the management controller, execution controllers to be updated based on predetermined priorities;
transmitting, by the management controller, an update list of the execution controllers determined according to the predetermined priorities to the user terminal; and
performing, by the management controller, a control operation such that the user terminal outputs the update list of the execution controllers and update details.

5. The OTA update control method according to claim 1, wherein receiving either the approval or the denial comprises receiving or not receiving an OTA update immediate approval from the user terminal.

6. The OTA update control method according to claim 5, further comprising: when the OTA update immediate approval is received, determining whether to receive the OTA update based on a state of charge (SOC) of a battery of a vehicle among vehicle status information from the user terminal.

7. The OTA update control method according to claim 6, wherein determining whether to receive the OTA update based on the SOC of the battery comprises:
calculating power to be consumed during the OTA update based on a driving current by execution controllers to be updated and an OTA update time based on update data capacity by the execution controllers;
calculating the SOC after completion of the OTA update based on the calculated power; and
determining a vehicle updatable status after the OTA update based on the calculated SOC.

8. The OTA update control method according to claim 5, further comprising: when the OTA update immediate approval is not received, receiving either the approval or the denial of the OTA update based on a predetermined update schedule.

9. The OTA update control method according to claim 8, wherein the receiving either the approval or the denial of the OTA update based on the predetermined update schedule comprises: receiving the approval when a current time is within a range of an OTA update reservation setting time based on the predetermined update schedule.

10. A computer-readable recording medium for storing a program for executing the OTA update control method according to claim 1.

11. An OTA update control system comprising:
an OTA server;
a management controller connected to the OTA server through wireless communication and configured to receive update data from the OTA server;
a plurality of execution controllers configured to execute OTA update based on the update data received from the management controller;
an communication controller connected to the management controller through intra-vehicle communication; and
a user terminal connected to the communication controller through wireless communication,
wherein:
the management controller is configured to:
transmit OTA update information to the user terminal through the communication controller, and
receive either an OTA update approval or a denial of the OTA update based on the OTA update information from the user terminal through the communication controller,
the execution controllers are configured to execute the OTA update based on the OTA update approval, and
each of the management controller, the execution controllers and the communication controller respectively include a processor and a non-transitory medium containing program instructions executed by the processor.

12. The OTA update control system according to claim 11, wherein the OTA update information comprises at least one of vehicle status information, information about the execution controllers to be updated, an update list, or update details.

13. The OTA update control system according to claim 12, wherein the management controller is configured to:
determine which execution controller among the execution controllers is to be updated based on predetermined priorities,
transmit an update list of the execution controllers determined based on the predetermined priorities to the user terminal, and
perform a control operation such that the user terminal outputs the update list of the execution controllers and update details.

14. The OTA update control system according to claim 13, wherein the management controller is configured to receive an OTA update immediate approval from the user terminal.

15. The OTA update control system according to claim 14, wherein when the OTA update immediate approval is received, the management controller is configured to receive either the OTA update approval or the denial of the OTA update based on an SOC of a battery of the vehicle among the vehicle status information from the user terminal upon.

16. The OTA update control system according to claim 15, wherein the management controller is configured to:
calculate power to be consumed during the OTA update based on a driving current by the execution controllers to be updated and an OTA update time based on update data capacity by the execution controllers,
calculate the SOC after completion of the OTA update based on the calculated power, and
determine a vehicle updatable status after the OTA update based on the calculated SOC.

17. The OTA update control system according to claim 14, wherein when the OTA update immediate approval is not received, the management controller is configured to receive either the OTA update approval or the denial of the OTA update based on a predetermined update schedule upon.

18. The OTA update control system according to claim 17, wherein the management controller is configured to receive the OTA update approval when a current time is within a range of an OTA update reservation setting time based on the predetermined update schedule.

19. The OTA update control system according to claim 12, wherein when the OTA update approval from the user terminal is received, the management controller is configured to update the execution controllers to the update data.
